(19) United States
(12) Patent Application Publication
(10) Pub. No.: US 2025/0238245 A1
(43) Pub. Date: Jul. 24, 2025

(54) System and Method for Providing Live Information Screensaver on a Living Room Device

(71) Applicant: Glance InMobi Pte. Limited

(72) Inventors: Manish Kumar Gupta, Bengaluru (IN); Chandrashekhar Iyer, Bengaluru (IN); Maxan Saxena, Bengaluru (IN); K.V. Nanjaraje Urs, Bengaluru (IN)

(73) Assignee: Glance InMobi Pte. Limited, (omitted)

(21) Appl. No.: 18/984,966

(22) Filed: Dec. 17, 2024

(30) Foreign Application Priority Data
Jan. 22, 2024 (IN) 202411004298

(51) Int. Cl. G06F 9/451; G06T 11/00

(52) U.S. Cl. CPC G06F 9/451; G06T 11/00; G06T 2211/441

(57) ABSTRACT

The present invention relates to a system and method for providing live information screensaver on a living room device. The method comprises fetching, a live information content for the one or more screensaver, the live information content comprising a set of one or more information pieces, extracting a set of keywords in the live information content, the set of keywords comprising one or more keywords related to the one or more information pieces, generating one or more images related to the one or more information pieces, wherein the one or more images are generated based on the one or more keywords, and the one or more information pieces, stitching the one or more images with the one or more information pieces to generate one or more live information screensavers; and providing the one or more live information screensavers.

### FIELD OF THE INVENTION

Embodiments of the present disclosure relate to the field of screensavers. More particularly, embodiments of the present disclosure relate to a system and method for providing live information screensaver on a living room device.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The evolution of technology has significantly transformed the way individuals engage with and perceive ed devices such as laptops, mobile phones and televisions (TVs). More specifically, conventional television usage involves active consumption with users deliberately tuning in to specific programs. However, a notable shift has been observed in the prevalence of the ambient state of smart TVs, where the users choose to keep their smart TVs on during periods of inactivity, primarily for the aesthetic ambiance it provides. Additionally, an ambient mode is offered by the smart TVs that allows the user to display a variety of content on the screen such as images, artwork, weather updates, etc.

The ambient mode has been regarded as a passive and visually pleasing feature. The users frequently cast glances at the ambient screen, but this interaction typically yields no substantive value beyond the realm of visual aesthetics. During the ambient mode, a plurality of content in form of wallpaper and widgets are displayed onto the screen of the smart TV. Leading brands have introduced visually captivating screensavers that activate when the screen is idle, transforming the otherwise dormant display into a visually engaging experience. Furthermore, the users are permitted to choose from various pre-installed screensavers, with options ranging from scenic landscapes to abstract art.

The screensavers include wallpaper and widgets that contribute to the visual and functional aspects. The wallpaper generally includes one or more images which may be static or dynamic. The images may include scenic landscapes or abstract art or any other digital illustrations. The widget, on the other hand, is a small, interactive application or tool that is typically present in a dedicated area of the wallpaper. The widgets provide information, quick access to specific functionalities, or serve as shortcuts to applications. For instance, a weather widget might display the current temperature and forecast, a clock widget can show the time in a specific time zone, and a calendar widget might provide a snapshot of upcoming events.

Moreover, several systems and methods are available in the public domain to provide a plethora of screensavers for electronic devices such as smart TVs and laptops. With the advancement in graphics technology, the currently available systems and methods are able to provide high quality screensavers which enhanced display resolutions, and improved color depth. Furthermore, there are systems and methods available in the market which produced screensaver which are beyond a basic animation and include visual effects, 3D graphics, and interactive elements.

Nevertheless, despite these advancements, the conventional systems, or methods for generating the screensaver for ambient mode still fail to deliver a truly immersive user experience or live information, such as news updates or stock market data. Moreover, the users increasingly desire customized, dynamic and real-time information, which is absent in conventional systems and methods. Additionally, the conventional systems and methods provide static and outdated information to the user, further diminishing the overall user experience.

Furthermore, a critical limitation of conventional systems and methods lies in their inability to cater to users' preferences through customization. The static content provided by the known solutions hampers the users from tailoring the information according to personal preferences or interests. As a result, the users find themselves restricted in their ability to interact with and personalize their ambient screens.

This gap in functionality not only detracts from the immersive potential of ambient display technologies but also underscores the pressing need for innovation and improvement. To fully realize their potential in enhancing the user experience during passive television viewing, there is a clear necessity for advancements that address the limitations of conventional systems. Additionally, the users seek a more engaging and customizable experience, with access to dynamic, real-time information seamlessly integrated into their ambient screensavers.

Thus, there exists an imperative need in the art to provide live information screensaver for enhancing the overall user experience.

### OBJECTS OF THE DISCLOSURE

This section is provided to introduce certain objects and aspects of the present invention in a simplified form that are further described below in the description.

In order to overcome at least a few problems associated with the known solutions as provided in the previous section, an object of the present invention is to substantially reduce the limitations and drawbacks of the prior arts as described hereinabove.

Another object of the invention is to provide a method and a system for providing live information screensaver on a living room device such as smart TV that enhances an overall user experience.

Yet another object of the invention is to provide a method and a system for providing live information screensaver, that is able to deliver customized and dynamic screensaver to a user.

Yet another object of the invention is to provide a method and system for providing customized live information screensaver based on user preferences to deliver an enhanced user experience.

Yet another object of the invention is to provide a method and a system for providing live information screensaver, that is able to fetch a live information and extract a set of keywords from the live information via a processing unit.

Yet another object of the invention is to provide a method and a system for providing live information screensaver, that implements a generative unit for integrating one or more images with one or more information pieces present in the live information to deliver the customized screensaver.

Yet another object of the invention is to provide a method and a system for providing a live information screensaver, that is able to provide real time updates such as news and sports in the live information screensaver.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method for providing one or more live information screensavers on a living room device. The method comprises fetching, by a processing unit, a live information content for the one or more screensaver. The live information content comprises a set of one or more information pieces. The method comprises extracting, by the processing unit, a set of keywords in the live information content. The set of keywords comprising one or more keywords related to the one or more information pieces. The method comprises generating, by a generative AI unit, one or more images related to the one or more information pieces. The one or more images are generated based on the one or more keywords, and the one or more information pieces. The method comprises stitching, by the generative AI unit, the one or more images with the one or more information pieces to generate one or more live information screensavers. The method comprises providing, on the ed living room device by the generative AI unit, the one or more live information screensavers.

An aspect of the present disclosure may relate to a system for providing one or more live information screensaver on a living room device. The system comprises a processing unit configured to fetch a live information content for the one or more screensaver. The live information content comprising a set of one or more information piece. The processing unit is configured to extract a set of keywords in the live information content. The set of keywords comprises one or more keywords related to the one or more information pieces. The system comprises a generative AI unit configured to generate one or more images related to the one or more information pieces. The one or more images are generated based on the one or more keywords, and the one or more information pieces. The generative AI unit is configured to stitch the one or more images with the one or more information pieces to generate the one or more live information screensavers. The generative AI unit is configured to provide the one or more live information screensavers on the living room device.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art, that other connections may also be possible, without departing from the scope of the invention. All sub-components within a component may be connected to each other, unless otherwise indicated.

FIG. 1 illustrates an exemplary block diagram of a system for providing one or more live information screensavers, in accordance with exemplary embodiments of the present disclosure.

FIG. 2(a) and FIG. 2(b) illustrate exemplary schematic diagrams of system for providing one or more live information screensavers, in accordance with exemplary embodiments of the present disclosure.

FIG. 3 illustrates another exemplary block diagram of the system for providing one or more live information screensavers implemented as web application, in accordance with exemplary embodiments of the present disclosure.

FIG. 4 illustrates a method flow diagram for providing one or more live information screensavers, in accordance with exemplary embodiments of the present disclosure.

FIG. 5 illustrates an exemplary live information screensaver, in accordance with exemplary embodiments of the present disclosure.

The foregoing shall be more apparent from a more detailed description of the invention below.

### DETAILED DESCRIPTION OF THE DISCLOSURE

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As used herein, “databased” or “internal storage unit” or cache memory unit” or “memory unit” refers to a machine or computer-readable medium including any mechanism for storing information including but not limited to text, images, audio, and video files in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the server/system/user device to perform their respective functions.

As discussed in the background section, the current known solutions have several shortcomings. The present disclosure aims to overcome the above-mentioned and other existing problems in this field of technology by providing a system and method for providing live information screensaver for delivering live and up-to-date information on a living room device such as a smart television in real time, ensuring that a user has access to latest news, updates, or relevant content without actively seeking it, thereby adding a value to a user experience by providing enhanced dynamically generated and engaging screensaver. Particularly, the present disclosure provides a more robust solution for providing live information screensaver to a living room device such as smart television. Also, the solution encompasses use of live information collected from third party vendors and generating a wallpaper and a widget which presents the live information in a much more glanceable format. For instance, the one or more live information screensavers may include one or more wallpapers and/or one or more widgets. The one or more wallpapers may provide the live and trending information such as entertainment, business, politics, global news, sports and alike. The one or more widgets may include live weather, live sports, latest news, and trending videos. For example, in a scenario when any match and/or game is live, a minute-by-minute update is provided to the user for the live match and/or game through the one or more live information screensavers.

The invention first fetches a live information content for the one or more screensaver. The live information content includes a set of one or more information pieces. This could be in the form of news articles in the form of web pages or RSS feeds, sports scores and stats, stock prices, weather details through APIs. For example, if the live information content is related to a sports match, then the one or more information pieces are related to the highlights, score, player or a combination thereof. Further a set of keywords are extracted from the live information content. The set of keywords includes one or more keywords which are related the one or more information pieces. Thereafter, one or more images related to the one or more information pieces are generated. Additionally, the one or more images are generated based on the one or more keywords. The generated images provide a visual representation of the information or content. Furthermore, the one or more images are stitched with the one or more information pieces for obtaining the one or more live information screensavers which are then provided to the user or a digital device such as smart TV, smart phone, electronic tablet which is accessed by the user. All of the above steps happen in near real time, thereby generating images as soon as information/content is received through the sources.

Therefore, the present disclosure provides a solution that incorporates a processing unit and a generative AI unit for providing live information screensaver to the living room device. The approach disclosed in the present disclosure is technically advanced over the existing approaches as it provides dynamically generated, live, aesthetic, useful information screensaver according to the user data. Moreover, the processing unit is configured to fetch a live information content based on a user data such as user preference, user behavior for ensuring that relevant live information is presented to the user in the form of one or more live information screensavers. Further, prior to extracting the one or more keywords from the live information, the one or more information pieces in the live information are ranked by a ranker unit according to latest trends and/or user preferences, ensures that relevant live information is presented to the user. Thus, providing real time insights and allowing the user to access the most up-to-date and pertinent content and ensuring a personalized and emotional resonant experience which allows the user to engage with the one or more live information screensavers that aligns with the user preference.

Hereinafter, exemplary embodiments of the present disclosure will be described in detail with reference to the accompanying drawings so that those skilled in the art can easily carry out the solution provided by the present disclosure.

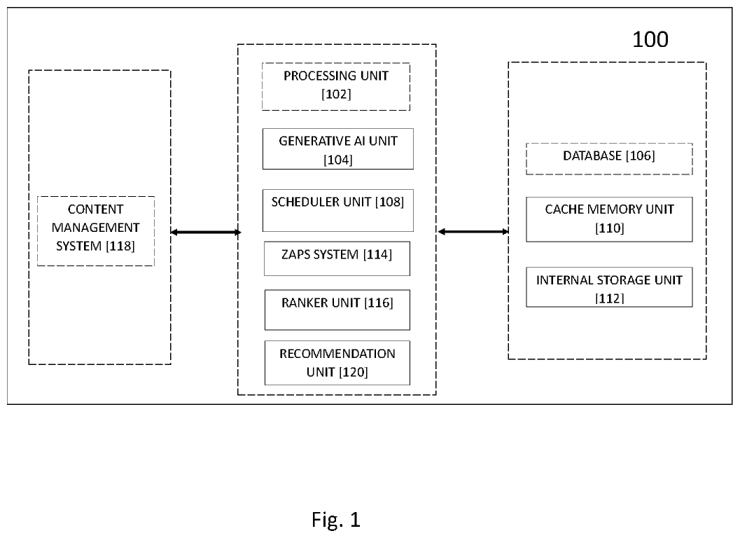

Referring now to FIG. 1, an exemplary system diagram [100] for providing live information screensaver to a living room device, in accordance with exemplary embodiments of the present invention is shown. The system [100] encompasses at least one processing unit [102], a generative AI unit [104], a database [106], a scheduler unit [108], a cache memory unit [110], an internal storage unit [112], a zaps system [114], a ranker unit [116], a content management system [118], a recommendation unit [120]. All of these components/units of the system [100] are assumed to be connected to each other unless otherwise indicated below and working in conjunction to achieve the objectives of the present invention. While only a few exemplary units are shown in FIG. 1, it may be understood that the system [100] may comprise multiple such units or the system [100] may comprise any such number of the units performing said functionalities, obvious to a person skilled in the art or as required to implement the features of the present disclosure.

In an implementation, the system [100] may be implemented in other computer system configurations, including hand-held devices, multiprocessor systems, microprocessor based or programmable consumer electronics, network personal computers, minicomputers, mainframe computers, and the like.

In an implementation, the system [100] may be implemented in a processor of a digital device. The digital device may include but is not limited to a network TV, a Hybrid Broadcast Broadband TV (HBBTV), a smart TV, Internet Protocol TV (IPTV), and personal computer (PC), or mobile/handheld devices such as a Personal Digital Assistant (PDA), smart phone, tablet PC, or notebook computer. The digital device may be connected to one or more other digital devices through a wired network or a wireless network, paired or connected to an external server. Further, the digital device in the present disclosure may be referred to a configuration having only a panel, set-top box (STB), or a set including the system [100].

The system [100] is configured to provide live information screensaver with the help of the interconnection between its components/units.

In order to provide live information screensaver to the living room device, firstly, the processing unit [102] is configured to fetch a live information content. The live information content comprises a set of one or more information pieces. In an implementation, the processing unit [102], for fetching the live information content for the one or more screensaver, is configured to collect, via the zaps system [114], the live information content from one or more third-party vendors. In an implementation, the zaps system [114] may connect with the one or more third-party vendors through one or more application programming interface (APIs). Moreover, the APIs acts as standard interfaces and specifies a set of rules and structure for a transmission of data i.e. live information content. The zaps system [114] may request, retrieve data, execute a set of operations. The processing unit [102] is further configured to store the live information content collected from one or more third-party vendors in a database [106]. Further, in an implementation, the processing unit [102], for fetching the live information content for the one or more screensaver is configured to collect, via a content management system [118], the live information content from an internal storage unit [112]. The processing unit [102] is further configured to store the live information content collected from the internal storage unit [112] in the database [106].

In an implementation, each live information screensaver from the one or more live information screensavers comprises a set of frames including one or more frames. Further, in an event the set of frames comprises a plurality of frames, said each live information screensaver includes a timeline. The timeline includes a time stamp corresponding to each frame from the plurality of frames.

For example, the live information screensaver may be related to a football match in which the timeline is displayed which shows a plurality of key moments. This feature provides an immersive experience to the user by allowing the user to stay updated about the match highlights, goals, events, etc.

For example, the processing unit [102] is configured to fetch live information content such as reputable news channels or aggregators, retrieving the latest headlines, breaking news, and feature stories from a third-party vendor for enriching a user experience with real-time and diverse data. The third-party vendor may include news channels and aggregators, financial market applications, entertainment applications, social media feeds, weather applications and the like.

For instance, the news channel and aggregators may provide the live information content that include reputable news, both local and global, that contribute real-time updates and breaking news stories. Moreover, the news aggregators may consolidate the live information content from one or more sources for ensuring a comprehensive and up-to-the-minute newsfeed. Additionally, the financial market applications may provide livestock prices, market trends, and financial news, catering about economic developments. Further, the entertainment applications may deliver live updates on trending movies, TV shows, celebrity news, and cultural events, enhancing the user's entertainment experience. Likewise, the social media feeds may provide real-time updates from the user's social network, ensuring that the user is connected with the latest posts and trends. In addition to this, the weather applications may provide live weather updates, forecasts, and alerts, enabling the user to stay informed about current and upcoming one or more weather conditions in the respect location or other specified areas.

In an implementation, the processing unit [102] collects the live information content from the one or more third-party vendors based on a user data associated with at least one of the living room device and one or more user devices in communication with the living room device. The user data include but not limited to user preference, user behaviour, user mood/emotions. The one or more user devices include but not limited to smart phone, smart watch, electronic tablet.

For example, if the user data associated with the one or more user device indicates that the user is more inclined towards a football match, then the processing unit [100] fetch the live information content related to the football match to provide real time insights to the user in the form of one or more live information screensavers. Hence, the system offers a real time and emotionally enriched viewing experience to the user.

In an implementation, the processing unit [102] collects the live information content from the internal storage unit based on the user data associated with at least one of the living room device and the one or more user devices in communication with the living room device.

For another example, the collection of the live information content from the one or more third-party vendors is done on the basis of the user data such as a preference regarding news type.

For instance, if the user has a distinct inclination towards stock news in comparison with other forms of information, then the live information content related to the stock news is collected. In addition to this, the collection of live information may be based on one or more emotions expressed by the user on the one or more user device such as mobile phone, thereby ensuring that the one or more live information screensavers provided to the living room device aligns with interest of the user and resonates with an emotional context of the user.

Moreover, the amalgamation of one or more third-party vendors transforms the live information screensaver into a dynamic, ever-evolving dashboard of information, tailored to the user's interests and preferences and ensures that the live information screensaver remains a vibrant and indispensable tool for the user seeking immediate access to a broad spectrum of real-time information.

Further, upon fetching the live information, the processing unit [102] is configured to extract a set of keywords in the live information content, the set of keywords comprises one or more keywords related to the one or more information pieces. For example, the processing unit [102] may extract a set of keywords such as “victory”, “India” from the live information content such as sports news.

In an implementation, the processing unit [102] is configured to collect a metadata related to at least one of the one or more information pieces and an updated information related to the at least one of the one or more information pieces. For instance, when fetching news articles, the metadata may include details such as the publication date, author, and keywords associated with each article. The metadata provide a context and an additional information about the news content. Furthermore, in the context of a financial market data, the metadata may encompass information like the timestamp of the latest stock price update, trading volume, and percentage change. Additionally, for weather updates, metadata may include time of a last weather report, and any relevant weather conditions (e.g., sunny, rainy, or cloudy). In an implementation, the processing unit [102] collects the metadata based on the user data associated with at least one of the living room device and the one or more user devices in communication with the living room device.

In an implementation, wherein prior to the processing unit [102] extracting the set of keywords in the live information content, the ranker unit [116] is configured to rank the one or more information pieces.

In an implementation, the ranker unit [116] is configured to rank the one or more information pieces based on user preferences. In addition to this ranking of the one or more information pieces may be done according to popularity, relevancy, activity of the user or a combination thereof. The user preferences may include, but is not limited to, favourite sport, athletes or teams, social network information, demographic information, contact information.

In an implementation, the system comprises a recommendation unit [120], wherein prior to the processing unit [102] extracting the set of keywords in the live information content, the recommendation unit [120] is configured to perform one or more of a short title preparation, and a language conversion process for the one or more ranked information pieces.

Further, the generative AT unit [104] is configured to generate one or more images related to the one or more information pieces. The one or more images are generated based on the one or more keywords and the one or more information pieces. For example, the one or more information pieces and the one or more keywords are related to a weather content such as heavy rainfall, or cloudy weather, then the generative AI unit [104] is configured to generate one or more images related to heavy rainfall or cloudy weather.

Additionally, the generative AI unit [104] assists in providing one or more visually compelling and contextually relevant images for providing the one or more live information screensavers. In an implementation, the generative AI unit [104] may utilize one or more techniques such as generative pre-trained transformer technique, natural language processing techniques or any other technique as may be obvious to a person skilled in the art for implementation of the features of the present disclosure.

Further, upon generating the one or more images, the generative AI unit [104] is configured to stitch the one or more images with the one or more information pieces to obtain the one or more live information screensavers that is provided to the living room device such as smart TV.

In an implementation, the stitching of the one or more images to each of the one or more information pieces with the one or more information pieces may be done by an overlaying technique, a side-by-side placement technique, a blending technique, a SIFT (Scale-Invariant Feature Transform) stitching, a SURF (Speeded Up Robust Features) stitching, an ORB (Oriented FAST and Rotated BRIEF) stitching, or a combination thereof.

For example, the generative AI unit [104] may integrate the one or more image generated on the basis of the one or more keywords with the one or more information pieces to obtain the one or more life information screensaver.

For another example, if the generated one or more images are related to heavy rainfall in a particular location, and the one or more keywords or the one or more information pieces include “precipitation rate is 8.9 mm per hour”, then the generative AI unit [104] stitch the images related to heavy rainfall with the information piece “precipitation rate is 8.9 mm per hour” to obtain the one or more live information screensavers.

In an implementation, the scheduler unit [108] is configured to read, in the database [106], the one or more live information screensavers. Further, the scheduler unit [108] is configured to store, in a cache memory unit [110], the one or more live information screensavers. The scheduler unit [108] is further configured to read, in the database [106], the one or more live information screensavers at a pre-defined frequency.

For example, the generative AI unit [104] has provided the one or more live information screensavers, each showcasing a real-time content update, so the scheduler unit [108] may strategically set or repeat the one or more live information screensavers at the pre-defined intervals.

In an implementation, the system [100] aims to provide live and trending information to the user through the one or more live information screensavers. The one or more live information screensavers may include one or more wallpapers and/or one or more widgets. Further, the user may customize one or more formats of the ne or more wallpapers and/or one or more widgets. The one or more wallpapers may provide the live and trending information such as entertainment, business, politics, global news, sports and alike. The one or more widgets may include live weather, live sports, latest news, and trending videos. For example, in a scenario when any match and/or game is live, a minute-by-minute update is provided to the user for the live match and/or game through the one or more live information screensavers.

In an implementation, the system [100] aims to provide aesthetic, live and personalized information to the user through the one or more live information screensavers. The system [100] utilizes the one or more third party vendors to fetch the live information content and render the live information content on the digital device in a glanceable format. Further the one or more live information screensavers may include one or more wallpapers and/or one or more widgets.

In an implementation, the one or more wallpapers may be dynamic wallpapers to provide the live information to the user and the one or more wallpapers are updated in 5 seconds or 10 seconds. The one or more widgets are of a particular category, topics which are transient in nature and may persist for a pre-defined duration of an activity. The one or more widgets may co-exist with the one or more wallpaper as overlays and occupy a pre-defined portion of the digital device.

For another example, the user may have the option to customize the one or more live information screensavers to display one or more live scores, match statistics, highlights. In addition, the one or more live information screensavers may aggregate one or more live delivery updates from one or more popular food delivery platforms, thereby allowing the user to track a real-time status of the orders, including order preparation, dispatch, and estimated delivery time. Moreover, the one or more live information screensavers may provide a real-time view of a specific location which may be the user's home security camera, a scenic outdoor view, or any other relevant setting.

In an implementation, the system provides the one or more live information screensavers within a short duration, preferably in range from 3 to 4 seconds. Therefore, by providing live and useful information in an ambient mode and in a glanceable format, the solution as disclosed herein provides a practical, effective, personalized and scalable solution for providing the live information screensaver for digital devices like smart TVs, laptops and mobile phones. Moreover, the system also ensure that the live information content presented in the one or more live information screensavers aligns with the latest trends and the user preferences by utilization of the user content.

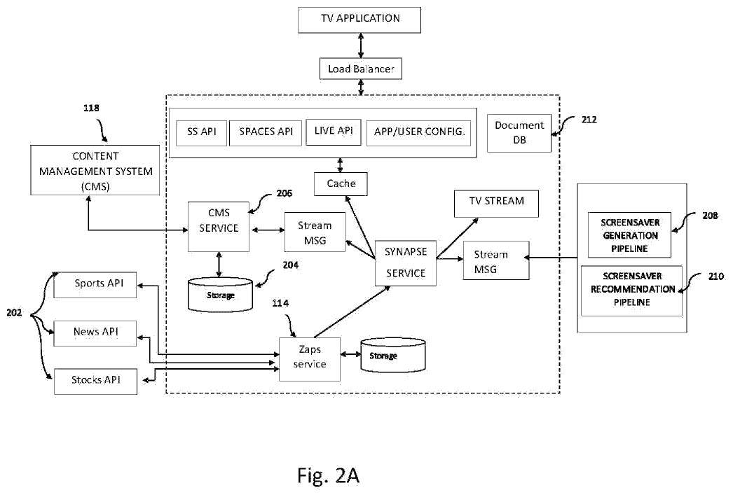

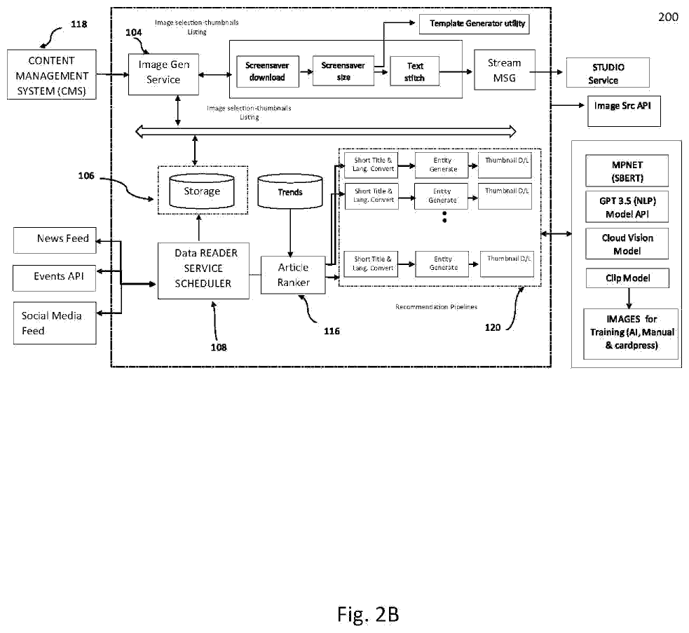

Referring now to FIG. 2(a) and FIG. 2(b), exemplary schematic diagrams [200] of the system for providing one or more live information screensavers, in accordance with exemplary embodiments of the present invention, are shown. According to FIG. 2(a) and in an implementation, the live information content [202] is fetched from one or more sources on the internet such as Sports API, News API, Stock API, RSS feeds, websites, or similar platforms. The one or more sources include the one or more third-party vendors, and the live information content is retrieved via the zaps system [114]. The content management system [118] assists in collecting the live information content from the internal storage unit [204] through the content management service [206]. Further, the system [100] works according to one or more screensaver generation pipelines [208] and one or more screensaver recommendation pipelines [210]. Further, once the generative AI unit [104] generates one or more live information screensavers, these are stored in a cloud-based database [212] and then displayed on the digital device. Additionally, the user is permitted to customize one or more configurations of the system [100] as well as one or more settings of the one or more live information screensavers displayed on the digital device. According to an implementation, the system [100] may utilize distinct pipeline structures for providing one or more live information screensavers related to news or sports. According to FIG. 2(b) and in an implementation the system [100] comprises of the scheduler unit [108] which configured to read, in the database [106], the one or more live information screensavers and store, in a cache memory unit [110], the one or more live information screensavers. In an implementation, a set of trending information is provided to the ranker unit [116] for evaluating ranking the set of trending information according to the user preference or any other relevant information, for providing the most impactful and pertinent content first to the user for enhancing the overall user experience. For example, in a scenario where the trending information includes breaking news, financial updates, and sports highlights, the ranker unit [116] may prioritize the display based on the urgency or user preferences. This ensures that the user is immediately exposed to the most relevant and compelling content when the user glances at the live information screensaver. Further as depicted in FIG. 2b, the system further comprises the recommendation unit [120] that is configured to perform one or more of a short title preparation, and a language conversion process for the one or more ranked information pieces. For example, in a recommended pipeline, the short title and language conversion, for instance, is prioritized to appear first on the digital device display. Further, in an implementation the scheduler unit [108] is configured to read, in the database [106], the one or more live information screensavers at a pre-defined frequency for enhancing the overall user experience. Moreover, for adding the live information content in the live information screensaver, the system [100] may utilize GPT 3.5 (NLP) model API, cloud vision model, clip model. Furthermore, the live information screensaver may be generated according to one or more pre-defined templates.

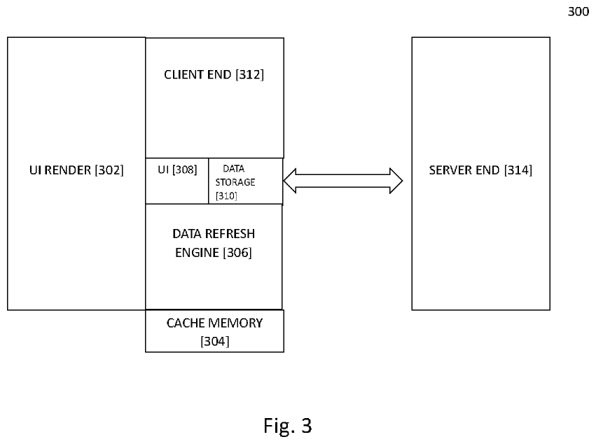

Referring now to FIG. 3, another exemplary block diagram of the system for providing one or more live information screensavers implemented as web application, in accordance with exemplary embodiment of the present invention is shown. According to FIG. 3 and in an implementation, the system [100] may be implemented as a web application [300], wherein the web application includes a user interface (UI) render [302], cache memory [304], data reference engine [306], UT [308], data storage [310], a client end [312], a server end [314]. The data storage [310] acts as the repository responsible for fetching the live information content, executing intricate data typing operations, and facilitating one or more data transformations, for ensuring that the live information fed into the system [100] is not only obtained efficiently but is also refined and structured for optimal use within the web application [300]. The UI [308] stands as a dynamic component, managing diverse aspects of visual presentation. The UI [308] adeptly handles one or more image renderings, orchestrates smooth image transitions, and facilitates image virtualizations, which collectively contribute to the aesthetic appeal of the live information screensaver, ensuring a visually engaging and captivating experience for the user. The data reference engine [306] is for enhancing the responsiveness of the system and is responsible for strategically caching live information content. Moreover, the data reference engine [306] orchestrates one or more data refresh cycles and initiates one or more data invalidations, thereby ensuring that the information presented to the user remains not only live but also current and relevant. The collaborative efforts of the client end [312] and server end [314] underpin the seamless communication and exchange of information within the web application [300]. The user interface (UI) render [302], cache memory [304], data reference engine [306], UI [308], data storage [310], client end [312], a server end [314] work in tandem to facilitate a robust and efficient flow of information, ensuring a real-time and responsive user experience. Hence, the system [100] delivers live information screensaver experience that is not only technically advanced but also visually captivating and dynamically responsive to the user preferences.

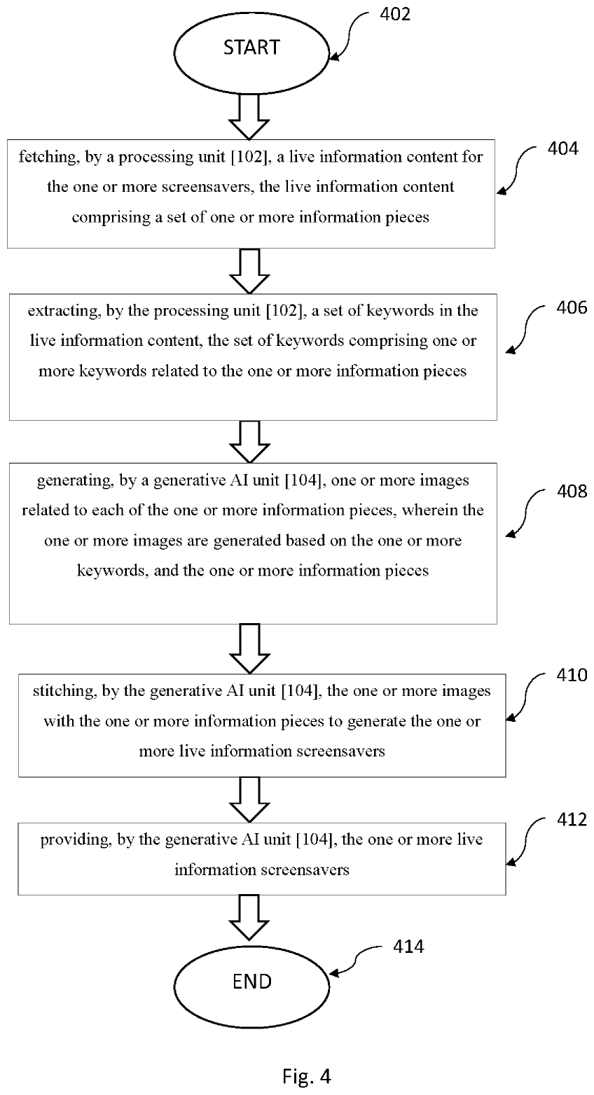

Referring now to FIG. 4, an exemplary flow diagram of the method for providing one or more live information screensavers, in accordance with exemplary embodiment of the present invention is shown. In an implementation, the method [400] is performed by the system [100]. As shown in FIG. 4, the method [400] may being upon receiving a request for providing the one or more live information screensavers. In an event the method [400] may be implemented at the digital device and a request for providing the one or more live information screensavers may be received at the method [400] from an application.

Next, at step [404], the method [400] comprises fetching, by a processing unit [102], a live information content for the one or more screensaver. The live information content comprises a set of one or more information pieces.

In an implementation, each live information screensaver from the one or more live information screensavers comprises a set of frames including one or more frames. Further, in an event the set of frames comprises a plurality of frames, said each live information screensaver includes a timeline. The timeline includes a time stamp corresponding to each frame from the plurality of frames.

For example, the live information screensaver may be related to a football match in which the timeline is displayed which showing a plurality of key moments, this feature provides an immersive experience to the user by allowing the user to stay updated about the match highlights, goals, events.

In an implementation, the fetching, by the processing unit [102], the live information content for the one or more screensaver comprises:
collecting, by the processing unit [102] via a zaps system [114], the live information content from one or more third-party vendors; and
storing, by the processing unit [102] in a database [106], the live information content collected from one or more third-party vendors.

In an implementation, the fetching, by the processing unit [102], the live information content for the one or more screensaver comprises:
collecting, by the processing unit [102] via a content management system [118], the live information content from an internal storage unit [112]; and
   storing, by the processing unit [102] in the database [106], the live information content collected from the internal storage unit [112]. In an implementation, the collection of the live information content from the one or more third-party vendors is based on a user data associated with at least one of the living room device and one or more user devices in communication with the living room device. The user data include but not limited to user preference, user behaviour, user mood/emotions. The one or more user devices include but not limited to smart phone, smart watch, electronic tablet.

In an implementation, the collection of the live information content from the internal storage unit is based on the user data associated with at least one of the living room device and the one or more user devices in communication with the living room device.

For example, if the user data associated with the one or more user device indicates that the user is more inclined towards a football match, then the processing unit [100] fetch the live information content related to the football match to provide real time insights to the user in the form of one or more live information screensavers. Hence, the system offers a real time and emotionally enriched viewing experience to the user.

For another example, the collection of the live information content from the one or more third-party vendors is done on the basis of the user data such as a preference regarding news type. For instance, if the user has a distinct inclination towards stock news in comparison with other forms of information, then the live information content related to the stock news is collected. In addition to this, the collection of live information may be based on one or more emotions expressed by the user on the one or more user device such as mobile phone, thereby ensuring that the one or more live information screensavers provided to the living room device aligns with interest of the user and resonate with an emotional context of the user.

For example, the live information content such as reputable news channels or aggregators, latest headlines, breaking news, and feature stories is fetched by the processing unit [102] from a third-party vendor for enriching a user experience with real-time and diverse data. The third-party vendor may include news channels and aggregators, financial market applications, entertainment applications, social media feeds, weather applications.

For another example, the collection of the live information content from the one or more third-party vendors is done on the basis of the user data such as a preference regarding news type. For instance, if the user has a distinct inclination towards stock news in comparison with other forms of information, then the live information content related to the stock news is collected. In addition to this, the collection of live information may be based on one or more emotions expressed by the user on the one or more user device such as mobile phone, thereby ensuring that the one or more live information screensavers provided to the living room device aligns with interest of the user and resonate with an emotional context of the user.

For instance, the news channel and aggregators may provide the live information content that include reputable news channels, both local and global, that contribute real-time updates and breaking news stories, moreover the news aggregators may consolidate the live information content from one or more sources for ensuring a comprehensive and up-to-the-minute newsfeed. Additionally, the financial market applications may provide livestock prices, market trends, and financial news, catering about economic developments. Further, the entertainment applications may deliver live updates on trending movies, TV shows, celebrity news, and cultural events, enhancing the user's entertainment experience. Likewise, the social media feeds may provide real-time updates from the user's social network, ensuring that the user is connected with the latest posts and trends. In addition to this, the weather applications may provide live weather updates, forecasts, and alerts, enabling the user to stay informed about current and upcoming one or more weather conditions in the respect location or other specified areas.

Moreover, the amalgamation of one or more third-party vendors transforms the live information screensaver into a dynamic, ever-evolving dashboard of information, tailored to the user's interests and preferences and ensures that the live information screensaver remains a vibrant and indispensable tool for the user seeking immediate access to a broad spectrum of real-time information.

Next, at step [406], the method [400] comprises extracting, by the processing unit [102], a set of keywords in the live information content. The set of keywords comprises one or more keywords related to the one or more information pieces. For example, a set of keywords such as “victory”, “India” are extracted from the live information content such as sports news, via the processing unit [102].

In an implementation, the method comprises collecting, by the processing unit [102], a metadata related to at least one of the one or more information pieces and an updated information related to the at least one of the one or more information pieces.

For instance, when fetching news articles, the metadata may include details such as the publication date, author, and keywords associated with each article. The metadata provide a context and an additional information about the news content. Furthermore, in the context of a financial market data, the metadata may encompass information like the timestamp of the latest stock price update, trading volume, and percentage change. Additionally, for weather updates, metadata may include time of a last weather report, and any relevant weather conditions (e.g., sunny, rainy, or cloudy). In an implementation, the collection of meta data is based on the user data associated with at least one of the living room device and the one or more user devices in communication with the living room device.

In an implementation, wherein prior to the extracting, by the processing unit [102], a set of keywords in the live information content, the method comprises ranking, by a ranker unit [116], the one or more information pieces. The method further comprises performing, by a recommendation unit [120], one or more of a short title preparation, and a language conversion process of the one or more ranked information pieces. The ranking of the one or more information pieces may be done according to popularity, relevancy, user preference, activity of the user or a combination thereof.

In an implementation, wherein the ranking, by a ranker unit [116], the one or more information pieces is based on a user preference. The user preference may include demographic information, favourite sport, athletes or teams, actor, or singer.

Next, at step [408], the method [400] comprises generating, by a generative AI unit [104], one or more images related to the one or more information pieces. The one or more images are generated based on the one or more keywords, and the one or more information pieces.

For example, the one or more information pieces and the one or more keywords are related to a weather content such as heavy rainfall, or cloudy weather, then the generative AI unit [104] is configured to generate one or more images related to heavy rainfall or cloudy weather.

In an implementation, for generation of the one or more images related to the one or more information pieces, the generative AI unit [104] may utilize one or more techniques such as generative pre-trained transformer technique, natural language processing techniques or any other technique as may be obvious to a person skilled in the art for implementation of the features of the present disclosure.

At step [410], the method comprises stitching, by the generative AI unit [104], the one or more images with the one or more information pieces to generate the one or more live information screensavers.

In an implementation, the stitching of the one or more images with the one or more information pieces may be done by an overlaying technique, aside-by-side placement technique, a blending technique, a SIFT (Scale-Invariant Feature Transform) stitching, a SURF (Speeded Up Robust Features) stitching, an ORB (Oriented FAST and Rotated BRIEF) stitching, or a combination thereof.

At step [412], the method comprises providing, by the generative AI unit [104], the one or more live information screensavers to the living room device such as smart TV

For example, the one or more images generated on the basis of the one or more keywords may be integrated with the one or more information pieces to obtain the one or more life information screensaver. For another example, if the generated one or more images are related to heavy rainfall in a particular location, and the one or more keywords or the one or more information pieces include “precipitation rate is 8.9 mm per hour”, then the generative AI unit [104] stitch the images related to heavy rainfall with the information piece “precipitation rate is 8.9 mm per hour” to obtain the one or more life information screensaver.

In an implementation, the method comprises reading, by a scheduler unit [108] in the database [106], the one or more live information screensavers. The method further comprises storing, by the scheduler unit [108] in a cache memory unit [110], the one or more live information screensavers.

In an implementation, wherein the reading, by the scheduler unit [108] in the database [106], the one or more live information screensavers is performed at a pre-defined frequency.

In an implementation, the method [400] aims to provide live and trending information to the user through the one or more live information screensavers. The one or more live information screensavers may include one or more wallpapers and/or one or more widgets. Further, the user may customize one or more formats of the ne or more wallpapers and/or one or more widgets. The one or more wallpapers may provide the live and trending information such as entertainment, business, politics, global news, sports and alike. The one or more widgets may include live weather, live sports, latest news, and trending videos. For example, in a scenario when any match and/or game is live, a minute-by-minute update is provided to the user for the live match and/or game through the one or more live information screensavers.

For example, the generative AI unit [104] has provided the one or more live information screensavers, each showcasing a real-time content update, so the scheduler unit [108] may strategically set or repeat the one or more live information screensavers at the pre-defined intervals.

In an implementation, the method [400] aims to provide aesthetic, live and personalized information to the user through the one or more live information screensavers. The method [400] utilizes the one or more third party vendors to fetch the live information content and render the live information content on the digital device in a glanceable format. Further the one or more live information screensavers may include one or more wallpapers and/or one or more widgets. In an implementation, the one or more wallpapers may be dynamic wallpapers to provide the live information to the user and the one or more wallpapers are updated every 5 seconds or 10 seconds. The one or more widgets are of a particular category, topics which are transient in nature and may persist for a pre-defined duration of an activity. The one or more widgets may co-exist with the one or more wallpaper as overlays and occupy a pre-defined portion of the digital device. In an implementation, the one or more live information screensavers maybe switched after every 5 minutes, ensuring a dynamic and ever-refreshing visual experience for the user. Alternatively, a customized pattern may be followed, based on specific user activity or time of day or any combination thereof.

For another example, the user may have the option to customize the one or more live information screensavers to display one or more live scores, match statistics, highlights. In addition, the one or more live information screensavers may aggregate one or more live delivery updates from one or more popular food delivery platforms, thereby allowing the user to track a real-time status of the orders, including order preparation, dispatch, and estimated delivery time. Moreover, the one or more live information screensavers may provide a real-time view of a specific location which may be the user's home security camera, a scenic outdoor view, or any other relevant setting.

In an implementation, the method provides the one or more live information screensavers within a short duration, preferably in range from 3 to 4 seconds.

The method terminates as step [414].

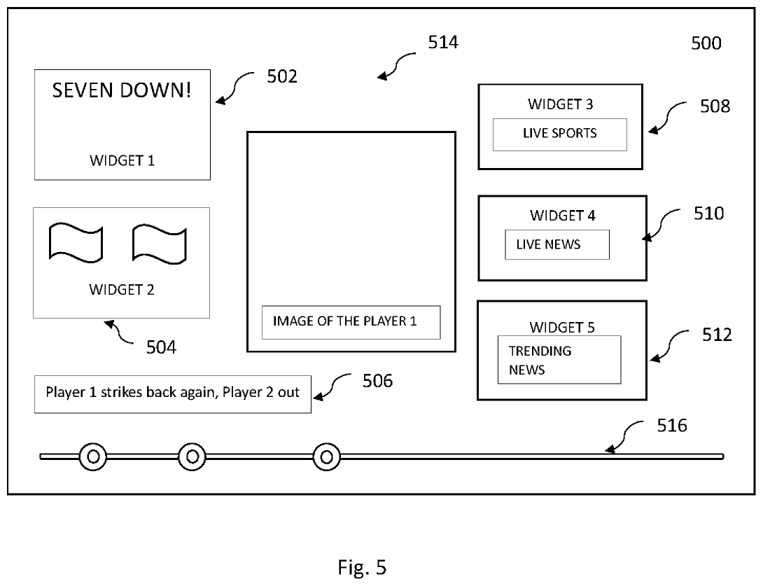

Referring now to FIG. 5, an exemplary live information screensaver, in accordance with exemplary embodiments of the present invention. The live information screensaver [500] in FIG. 5 is related to a cricket match. The live information content is dynamically sourced from a web platform dedicated to a cricket related content encompassing a diverse array of information such as live scores, highlights, and other pertinent updates and the set of keywords are extracted from the live information content such as scores, highlights. The live information screensaver includes an image [514] that act as a wallpaper that is generated according to one or more information pieces from the set of keywords and one or more widgets [502, 504, 508, 510, 512] are generated related to live sports, live news, trending videos via using the generative AI unit [104]. Furthermore, the generative AI stitches the image [514] related to the one or more information pieces [506] with the one or more information pieces to obtain the live information screensaver [500] related to the cricket match. The live information screensaver [500] related to the cricket match offers an adaptive visual representation of the live cricket match which provide the user with a captivating and contextually relevant background that evolves in real-time based on the unfolding events in the game. Furthermore, each live information screensaver [500] from the one or more live information screensavers comprises the set of frames including one or more frames. Further, in the event the set of frames comprises a plurality of frames, said each live information screensaver [500] includes the timeline [516]. The timeline [516] includes a time stamp corresponding to each frame from the plurality of frames. Therefore, the live information screensaver is fusion of the live information, adaptive wallpaper generation, and dynamically created widgets which not only elevates the aesthetic appeal but also transforms into an interactive and informative experience tailored to a preference or interest of the user.

The technical solutions in this disclosure propose a novel method and system for providing one or more live information screensavers to a living room device. The technical solutions of the present disclosure also provide a technical advancement over the currently known solution. The present solution is able to dynamically generate live wallpapers based on real-time collection of data in a matter of 3-4 seconds, without being computationally intensive, This vast increase in speed of generation of the live wallpaper owing to the solution of the present invention, makes the invention technically advanced when compared to prior known solutions. Particularly, the present disclosure provides a solution for providing one or more live information screensavers to the living room device such as smart TV that delivers live, aesthetic, dynamic and useful information to the user and transforms an ambient screen of digital device such as smart TVs into personalized, live, aesthetic information hubs through generative AI technology, which also deliver a seamless and engaging user experience. Moreover, the one or more live information screensavers offers dynamic wallpaper that covers the entire screen of the smart TV and is continuously updated at a customizable interval. Additionally the dynamic wallpapers of the one or more live information screensavers presents the live information content in a visually rich format. For example, images showcasing dynamic wallpapers with live updates across various categories such as entertainment, business, politics, global news, and sports. In addition to this, the one or more live information screensavers include one or more widgets which are transient overlays co-existing with the wallpaper, occupying a small portion of the screen, wherein the user is able to customize the one or more widgets based on personal preferences. For example, live sports widget displays real-time scores and updates for ongoing sports events like cricket, persists for the duration of the game. Delivery updates widget provides live delivery updates from food platforms showing progress until the order is delivered. Door Cam widget that displays the live view of a door camera when activity is detected, offering real-time updates. Some of the advantages of the present solution are aesthetic appeal, as the present solution enhances the visual appeal of the smart Tv by presenting information in a visually rich and dynamic manner, live and personalized updates where the user receives one or more real time updates on the screen, thereby enhancing the overall viewing experience. The present solution also allows the user to personalize the experience by customizing the one or more widgets based on their preferences. Additionally, the present solution may be implemented within various in-application (i.e., in-app) environments installed in various devices compatible with different operating systems, covering a wide range of applications and industries. Therefore, the solution as disclosed herein has several technical advantages over the existing solutions.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

We claim:

1. A method for providing one or more live information screensavers on a living room device, the method comprising:
fetching, by a processing unit [102], a live information content for the one or more screensaver, the live information content comprising a set of one or more information pieces;
extracting, by the processing unit [102], a set of keywords in the live information content, the set of keywords comprising one or more keywords related to the one or more information pieces;
generating, by a generative AI unit [104], one or more images related to the one or more information pieces, wherein the one or more images are generated based on the one or more keywords, and the one or more information pieces;
stitching, by the generative AI unit [104], the one or more images with the one or more information pieces to generate one or more live information screensavers; and
providing, by the generative AI unit [104] at the living room device, the one or more live information screensavers.

2. The method as claimed in claim 1, wherein the living room device is a living room device.

3. The method as claimed in claim 1, wherein each live information screensaver window from the one or more live information screensavers comprises a set of frames including one or more frames.

4. The method as claimed in claim 3, wherein in an event the set of frames comprises a plurality of frames, said each live information screensaver includes a timeline,
wherein the timeline includes a time stamp corresponding to each frame from the plurality of frames.

5. The method as claimed in claim 1, wherein the fetching, by the processing unit [102], the live information content for the one or more screensaver comprises:
collecting, by the processing unit [102] via a zaps system [114], the live information content from one or more third-party vendors; and
storing, by the processing unit [102] in said database [106], the live information content collected from one or more third-party vendors in a database [106].

6. The method as claimed in claim 5, wherein the collection of the live information content from the one or more third-party vendors is based on a user data associated with at least one of the living room devices and one or more user devices in communication with the living room device.

7. The method as claimed in claim 1, wherein the fetching, by the processing unit [102], the live information content for the one or more screensaver comprises:
collecting, by the processing unit [102] via a content management system [118], the live information content from an internal storage unit [112]; and
storing, by the processing unit [102] in said database [106], the live information content collected from the internal storage unit [112].

8. The method as claimed in claim 7, wherein the collection of the live information content from the internal storage unit is based on a user data associated with at least one of the living room devices and one or more user devices in communication with the living room device.

9. The method as claimed in claim 1, further comprising collecting, by the processing unit [102], a metadata related to at least one of the one or more information pieces and an updated information related to the one or more information pieces.
The method as claimed in claim 9, wherein the collection of meta data is based on a user data associated with at least one of the living room devices and one or more user devices in communication with the living room device.

10. The method as claimed in claim 2, further comprising:
reading, by a scheduler unit [108] in the database [106], the one or more live information screensavers; and
storing, by the scheduler unit [108] in a cache memory unit [110], the one or more live information screensavers.

11. The method as claimed in claim 5, wherein the reading, by the scheduler unit [108] in the database [106], the one or more live information screensavers is performed at a pre-defined frequency.

12. The method as claimed in claim 1, wherein prior to the extracting, by the processing unit [102], a set of keywords in the live information content, the method comprises:
ranking, by a ranker unit [116], the one or more information pieces; and
performing, by a recommendation unit [120], one or more of a short title preparation and a language conversion process for the one or more ranked information pieces.

13. The method as claimed in claim 7, wherein the ranking, by a ranker unit [116], the one or more information pieces is based on a user preference.

14. A system for providing one or more live information screensavers on a living room device, the system comprising:
a processing unit [102] configured to:
fetch a live information content for the one or more screensavers, wherein the live information content comprising a set of one or more information pieces;
extract a set of keywords in the live information content, wherein the set of keywords comprising one or more keywords related to the one or more information pieces; and
a generative AI unit [104] configured to:
generate one or more images related to the one or more information pieces, wherein the one or more images are generated based on the one or more keywords, and the one or more information pieces;
stitch the one or more images with the one or more information pieces to generate the one or more live information screensavers; and
provide, on the living room device, the one or more live information screensavers.

15. The system as claimed in claim 14, wherein the living room device is a television.

16. The system as claimed in claim 14, wherein each live information screensaver from the one or more live information screensavers comprises a set of frames including one or more frames.

17. The system as claimed in claim 16, wherein in an event the set of frames comprises a plurality of frames, said each live information screensaver includes a timeline,

18. The system as claimed in claim 17, wherein the timeline includes a time stamp corresponding to each frame from the plurality of frames.

19. The system as claimed in claim 14, wherein the processing unit [102], for fetching the live information content for the one or more screensavers, is configured to:
collect, via a zaps system [114], the live information content from one or more third-party vendors; and
store the live information content collected from one or more third-party vendors in a database [106].

20. The system as claimed in claim 19, wherein the processing unit [102] collects the live information content from the one or more third-party vendors based on a user data associated with at least one of the living room devices and one or more user devices in communication with the living room device.

21. The system as claimed in claim 14, wherein the processing unit [102], for fetching the live information content for the one or more screensavers is configured to:
collect, via a content management system [118], the live information content from an internal storage unit [112]; and
store the live information content collected from the internal storage unit [112] in the database [106].

22. The system as claimed in claim 21, wherein the processing unit [102] collects the live information content from the internal storage unit based on a user data associated with at least one of the living room devices and one or more user devices in communication with the living room device.

23. The system as claimed in claim 14, wherein the processing unit [102] is configured to collect a metadata related to at least one of the one or more information pieces and an updated information related to the at least one of the one or more information pieces.

24. The system as claimed in claim 23, wherein the processing unit [102] collects the metadata is collected based on a user data associated with at least one of the living room devices and one or more user devices in communication with the living room device.

25. The system as claimed in claim 14, wherein the system further comprises a scheduler unit [108] configured to:
read, in the database [106], the one or more live information screensavers; and
store, in a cache memory unit [110], the one or more live information screensavers.

26. The system as claimed in claim 23, wherein the scheduler unit [108] is configured to read, in the database [106], the one or more live information screensavers at a pre-defined frequency.

27. The system as claimed in claim 14, the system further comprising a ranker unit [116], wherein prior to the processing unit [102] extracting the set of keywords in the live information content, the ranker unit [116] is configured to:
rank the one or more information pieces;

28. The system as claimed in claim 25, wherein the ranker unit [116] is configured to rank the one or more information pieces is based on a user preference.

29. The system as claimed in claim 14, the system further comprising a recommendation unit [120], wherein prior to the processing unit [102] extracting the set of keywords in the live information content, the recommendation unit [120] is configured to:
perform one or more of a short title preparation, and a language conversion process for the one or more ranked information pieces.
